(19) United States
(12) Patent Application Publication
(10) Pub. No.: US 2008/0271681 A1
(43) Pub. Date: Nov. 6, 2008

(54) Loading Bar for Animal Transporter

(76) Inventor: Amanda Smith, Hook (GB)

Correspondence Address: CAESAR, RIVISE, BERNSTEIN,;COHEN & POKOTILOW, LTD., 11TH FLOOR, SEVEN PENN CENTER, 1635 MARKET STREET, PHILADELPHIA, PA, 19103-2212, US

(21) Appl. No.: 11/570,939

(22) PCT Filed: Apr. 26, 2005
(86) PCT No.: PCT/GB2005/001575

§ 371 Date: Dec. 19, 2006

(30) Foreign Application Priority Data
Jun. 23, 2004 (GB) 0414083.6
Aug. 16, 2004 (GB) 0418266.3

(51) Int. Cl. B60P 3/04

(52) U.S. Cl. 119/415

(57) ABSTRACT

A loading bar for fixing to a wall of an animal transporter adjacent a stall of the transporter is disclosed that comprises an elongate member having a front section located at a front of the stall, a rear section that in use extends across the rear end of the stall in the vicinity of the rear of the horse, and an intermediate section that extends in a direction along the length of the stall and interconnects the front and rear sections. At least said rear section is provided with a latch means that cooperates with a feature on the transporter, to hold the loading bar in a raised position across the stall when the front section is in a predefined position. The latch means is made of sound absorbing material and is remotely operable.

This invention relates to animal transporters such as horseboxes and horse trailers and in particular to loading bars for such transporters. Hereinafter references to a “transporter” shall be taken to include transporters for transporting such animals as horses, ponies, cattle, livestock, goats, donkeys and so forth.

There are many and varied transporters for the transport of ponies and horses. Generally speaking, they all comprise one or more stalls in which a horse is led and tied up at the front. All transporters include a “loading bar” which is raised into a position behind the rear of the horse once it is in the stall to stop the horse reversing out of the stall. An assistant is required to lift the loading bar into a position just behind the rear of the horse by raising the loading bar. Quite often horses become alarmed if someone approaches from the rear when they are in the stall to fix the loading bar in place, or if sudden noises are created behind them. Horses are unpredictable animals, and will often panic and kick out rearwards, sometimes causing injury to the assistant.

There are many instances when there is no assistant present and then the task of loading a horse into a horsebox becomes fraught with problems and can be extremely dangerous and it becomes impossible to place the loading bar in the correct position.

Reference is made to U.S. Pat. No. 4,355,594 and DE-A-3,916,458. Both of these disclosures relate to horse boxes in which the loading bar may be raised from the front by a single operator. Neither of these references however disclose a latch operating mechanism that junctions to operate the catch mechanism at the rear and neither of them gives consideration to the avoidance of alarming the horse by creating a sudden unexpected noise, such as a loud click when securing the loading bar in place. It has been found that even a dull click will frighten the horse.

The present invention overcomes this problem by controlling the movement of the latching action from the front and by providing sound absorbing materials and or resilient pads to suppress or eliminate clicking sounds when securing the loading bar in place.

An object of the present invention is to provide a loading bar for an animal transporter that enables a single person to lead the animal into a stall and secure the animal in place with a loading bar correctly located without frightening the animal by noises as the loading bar engages its locking mechanism.

A further object of the present invention is to provide a loading bar for an animal transporter that can be positioned and locked in place behind the animal single-handedly by a person at the front of the horsebox.

According to the present invention there is provided a loading bar as set out in the attached claims.

The present invention will now be described by way of the following non-limiting example, with reference to the accompanying drawings, in which:—

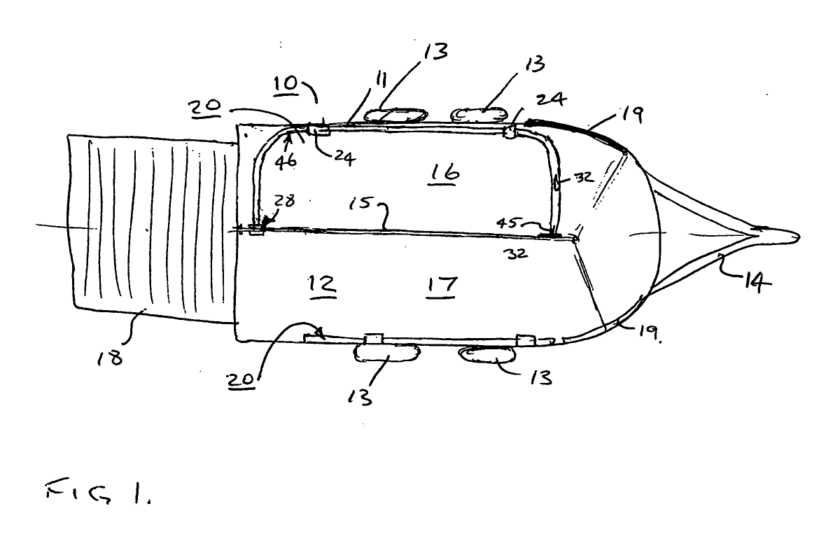

FIG. 1 is a schematic plan view of one form of horsebox incorporating a loading bar constructed in accordance with the present invention;

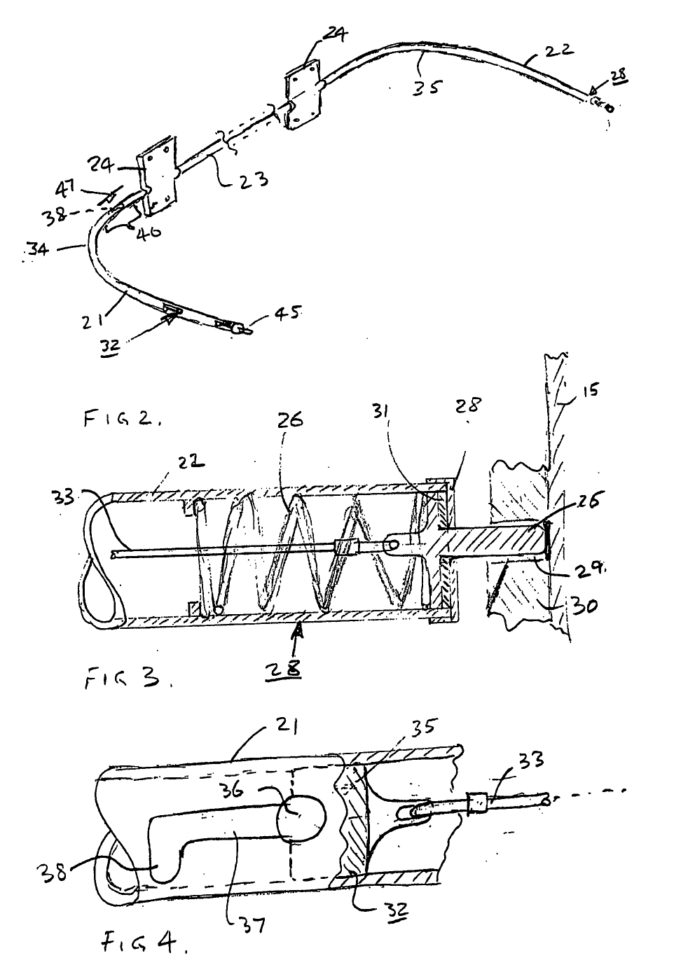

FIG. 2 shows a general assembly drawing of one form of loading bar constructed in accordance with the present invention;

FIG. 3 illustrates in greater detail a locking mechanism at the rear end of the loading bar shown in FIG. 2;

FIG. 4 shows in greater detail the latch operating mechanism at the front end of the loading bar of FIG. 2; and,

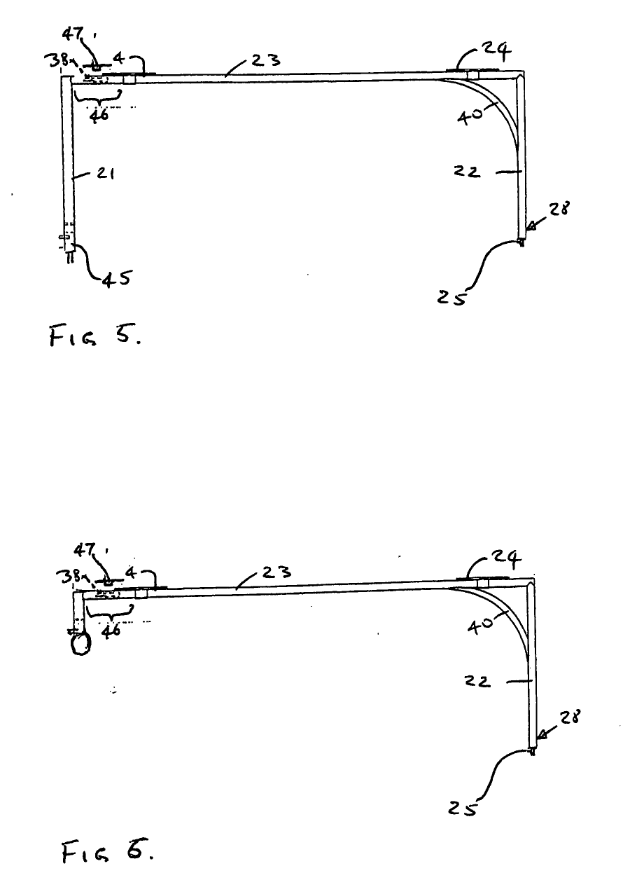

FIGS. 5 and 6 illustrate two further forms of loading bar constructed in accordance with the present invention.

Referring to FIG. 1, there is shown a schematic representation of a horsebox 10 comprising an outer body 11, of metal or wood construction, fixed to a base 12 that is mounted on twin axles that carry road wheels 13. The horsebox 10 has a towing hitch 14 for connection to a tow vehicle (not shown). The horsebox 10 has a central dividing wall 15 that divides the horsebox into two stalls 16, 17 located side by side. In some horseboxes the rear part of the dividing wall could be hinged by means of a hinge so that during loading of a horse into one of the stalls, the rear of the dividing wall can be swung back to give easier access for the horse entering the horsebox from the rear. In this case, when using a loading bar in accordance with the present invention, it is preferable to secure the hinged part so that it cannot swing about the hinge. In other horseboxes, the rear part of the dividing wall is fixed. This is preferred with the present invention. The horsebox has a rear door 18 that is lowered to form a ramp at the rear of the horsebox 10, and one or more front doors 19 at the front of the horsebox.

The horsebox 10 is fitted with two loading bars 20 constructed in accordance with the present invention. In FIG. 1 one of the loading bars is shown in the raised position, and the other in a lowered position. For loading the horse into one of the stalls the respective loading bar 20 would normally be lowered to an open position as will be explained later.

One of the loading bars is shown in more detail in FIG. 2 but it is to be understood the each loading bar 20 is of identical construction, with each being designed so as to extend across the appropriate stall. Referring to FIG. 2 the loading bar 20 comprises a length of hollow metal tubing that is bent to a generally “U” shape to define three main sections, namely, a front section 21, a rear section 22, and an intermediate section 23 that interconnects the front and rear sections 21, 22. The front and rear sections 21, 22 are dimensioned so that when they are in the raised position they each extend across the width of one of the stalls. The intermediate section 23 is mounted in two spaced supports 24 that are constructed to fix to the sidewall of the outer body 11 of the horsebox 10. Preferably the fixings making up the support 24 are compatible with existing fittings on the horsebox 10.

The intermediate section 23 is dimensioned so that the rear section 22 will locate behind the rear quarters of the horse when the bar is raised, and the front section 21 lies across the stall at the front of the horse. The rear section 22 is provided with a latch mechanism 25 (shown in greater detail in FIG. 3). The latch mechanism 28 comprises a plunger 26 that is biased in an outwards direction through an end cap 27. The plunger 26 engages in a recess 29 in a plate 30 that is fixed to the rear portion of the dividing wall 15. Importantly the end cap 27 is made of a plastics material or is provided with a resilient pad 31 or a sound absorbing material that cushions the plunger 26 when it snaps into position in the recess 29 so as not to frighten the horse by a loud click when the plunger 26 engages the recess.

The plunger 26 is connected to a latch operating mechanism 32 located at the front section 21 of the loading bar by a cable 33. The latch operating mechanism 32 is shown in more detail in FIG. 4. The front and rear corners 34, 35 of the loading bar 20 may be cut away to reveal a guide pulley (not shown) over which the cable 33 passes to reduce wear.

Referring to FIG. 4, the latch operating mechanism 32 comprises a bolt 35 to which the cable 33 is fitted. The bolt 35 slides inside the end of the front section 21 of the loading bar and has a handle 36 that slides in a slot 37. The cable 33 is pulled against the action of the spring 26 to retract the plunger 26 from engagement with the recess 29 by pulling the bolt 35 to the end of the slot 37 that is remote from the free end of the front section 21 and inserting the handle 36 into the retaining slot 38. Releasing the handle 36 from the retaining slot 38 releases the bolt 34 and the spring 26 urges the plunger outwards so as to be able to engage the recess 29 in the plate 30.

To protect the horse from injury the center section 23 and the front and rear sections 21, 22 are covered with a padded outer covering (not shown). This cover may be in the form of a split sleeve made of rubber or foam that is secured in place by ties (not shown) that can be removed for cleaning.

Referring to FIG. 5 there is shown an alternative design of loading bar in which the three sections 21, 22, 23 are made by welding three separate tubes or solid rods. Strengthening bars 40 are provided to give more rigidity to the loading bar 20. In the case of a hollow tubular structure, a latching mechanism 28 and a latch operating mechanism 32 similar to those of FIG. 2 are provided. In the case of the use of solid bars the latching mechanism 28 is operated by a cable 33 externally mounted on the bars (not shown) that constitute the front, rear and intermediate sections 21, 22, 23.

To load a horse into the horsebox single-handedly, the ramp at the rear of the horse box is lowered and the loading bar 20 for one of the stalls is lowered. A person leads the horse into one of the stalls. When the horse is in position in the stall the person leading the horse pulls up the loading bar 20 from the front and operates the latch operating means 32 to release the bolt 35 into the recess 38 in the plate 30. If desired, a second bolt 45 at the free end of the front section 21 can be added to secure the front section 21 in the raised position. In an emergency, if the horse panics, the loading bar 20 can be dropped immediately by pulling the plunger out of the recess 29 and dropping the loading bar to the open position.

A second horse can be loaded alongside the first horse in a similar way. The person leading the horse raises the second loading bar 20 from the front when the second horse is in position.

To release the horses from each stall the loading bar 20 is dropped from the front position by retracting the latch mechanism and the horse is led out of the front door 19.

In a modification of the above embodiments the latch operating mechanism 32 as described above may be located at the front region 46 of the intermediate section 23 close to the side wall of the horse box. The handle 36 of the bolt 35 may then be positioned relative to a stop member 47 on the side wall of the horsebox so that when it is in the cocked position with the plunger 26 retracted, the handle engages the stop member 47 as the bar is raised, and the stop member pushes the handle 36 out of the retaining slot 38 into the slot 37 to release the plunger 26. The slots 37, 38 are shown dotted in FIG. 1.

In the above examples the front section 21 extends across the width of the respective stall at the front of the stall. If desired the front section 21 could comprise a much shorter lever as shown in FIG. 6 that can be moved to, and from, a first position where the rear section 22 is operable (raised) and extends in a direction across the stall to and from a second position where the rear section 22 is lowered i.e. inoperable. A suitable latch operating mechanism 32 would be provided on or adjacent to the front section 21 in order to operate the latch mechanism 28 as described above.

In all of the above embodiments the catch is made of resilient materials such as plastics materials, e.g. nylon, so as to reduce the noise levels when the catch is operated thus avoiding frightening the horse.

1-16. (canceled)

17. A loading bar for fixing to a wall of an animal stall, the loading bar comprising an elongate member having a front section located at a front of the stall and which in use extends in a direction across a front end of the stall, a rear section that in use extends across the full width of a rear end of the stall in the vicinity of the rear of the animal, and an intermediate section that extends in a direction along the length of a first wall of the stall and interconnects the front and rear sections, at least said rear section being provided with a latch means for engaging a second wall of the stall opposite the first wall of the stall when the rear sections extends across the stall, characterized in that the front and rear sections are moveable simultaneously to, and from, a first lowered position where access to the stall is opened, and are raised upwardly to, and from, a second position where the rear section extend across the stall respectively behind an animal in the stall and the front section extends in a direction across the front of the stall in front of the animal in the stall.

18. A loading bar according to claim 17 for fixing to the wall of an animal stall that has a dividing wall that divides the stall into two adjacent stalls and defines said second wall of the or each stall, wherein the latch means of the rear section of the, or each bar, releasably cooperates with the dividing wall to hold the bar in a horizontal raised position across a respective stall when in use.

19. A loading bar according to claim 17 wherein the front section extends across the full width of the stall when it is in the raised second position.

20. A loading bar according to any one of claim 17 wherein the second wall of the or each stall has a part that releasably engages the latch means of the rear section when the rear section is raised to said second position, and that part is moveable away from the rear section to release the rear section and allow it to fall to the first position in an emergency.

21. A loading bar according to claim 18 wherein the front section extends across the full width of the stall when it is in the raised second position.

22. A loading bar according to claim 18 wherein the second wall of the or each stall has a part that releasably engages the latch means of the rear section when the rear section is raised to said second position, and that part is moveable away from the rear section to release the rear section and allow it to fall to the first position in an emergency.

23. A loading bar according to claim 19 wherein the second wall of the or each stall has a part that releasably engages the latch means of the rear section when the rear section is raised to said second position, and that part is moveable away from the rear section to release the rear section and allow it to fall to the first position in an emergency.

24. A loading bar according to claim 17 wherein a latch operating means is provided at or adjacent a location on the front section and is connected by a cable to the latch means at the rear section of the bar.

25. A loading bar according to claim 24 wherein the bar is of a solid construction and the cable runs externally of the bar.

26. A loading bar according to claim 17 wherein the latching means comprises a plunger that is biased to a position where, in use, it engages a locking feature on the second wall of the stall by a biasing means.

27. A loading bar according to claim 26 wherein the plunger is connected to a cable.

28. A loading bar according to claim 27 wherein the rear section is hollow and is provided with an end cap against which the plunger is biased by the biasing means.

29. A loading bar according to claim 28 wherein a resilient pad is located between the plunger and the end cap.

30. A loading bar according to claim 24 wherein the latch operating means comprises a bolt that slides in a slot, and said bolt is connected to the plunger of the latch means by the cable.

31. A loading bar according to claim 18 wherein a latch operating means is provided at or adjacent a location on the front section and is connected by a cable to the latch means at the rear section of the bar.

32. A loading bar according to claim 19 wherein a latch operating means is provided at or adjacent a location on the front section and is connected by a cable to the latch means at the rear section of the bar.

33. A loading bar according to claim 18 wherein the latching means comprises a plunger that is biased to a position where, in use, it engages a locking feature on the second wall of the stall by a biasing means.

34. A loading bar according to claim 19 wherein the latching means comprises a plunger that is biased to a position where, in use, it engages a locking feature on the second wall of the stall by a biasing means.

35. A loading bar according to claim 25 wherein the latch operating means comprises a bolt that slides in a slot, and said bolt is connected to the plunger of the latch means by the cable.

36. A loading bar according to claim 17 wherein the latch means is made of a sound absorbing material.
